(19) United States
(12) Patent Application Publication
(10) Pub. No.: US 2026/0359564 A1
(43) Pub. Date: Nov. 12, 2026

(54) SYSTEMS AND METHODS FOR PERSONALIZING A VIRTUAL AGENT TRAINED USING AN ARTIFICIAL INTELLIGENCE (AI) MODEL

(71) Applicant: FMR LLC, Boston, MA (US)

(72) Inventors: Tomas Zeman, Boston, MA (US); Mona Vernon, Boston, MA (US); Alexander Sieke, Greenwich, CT (US)

(21) Appl. No.: 19/199,676

(22) Filed: May 6, 2025

(51) Int. Cl. G06F 40/205; G06N 20/00

(52) U.S. Cl. CPC G06F 40/205; G06N 20/00

(57) ABSTRACT

A computer implemented method is provided for automatically generating a textual response to a message using a trained artificial intelligence (AI) model. The method includes receiving a request to customize the trained AI model and initiating a training phase comprising parsing the request to generate a set of fine-tuning parameters. The fine-tuning parameters include one or more of (i) a contextual prompt configured to capture a guardrail for specifying a desired subject matter within which the response falls, and (ii) a vector-based representation of a desired tone for the response. The method further includes generating the textual response to the message by inputting the message and the set of fine-tuning parameters into the trained AI model.

### BACKGROUND

### Technical Field

This application generally relates to systems, methods and apparatuses, including computer program products, for personalizing and customizing outputs from a trained artificial intelligence (AI) model.

### BACKGROUND

Companies increasingly use Large Language Models (LLM) to support back-office operations and interface with customers. Interactions that a human would have traditionally handled are now, in some cases, entirely fulfilled by an autonomous virtual agent implemented using LLM. This substitution can introduce several issues. One of the issues is the variability in the outputs generated. Because LLMs generate output probabilistically, the output is non-deterministic. For example, if ten customers asked an LLM a given query, it can potentially generate ten different responses. Another issue is the unpredictability in the outputs generated. For example, the responses can range from being humorous, e.g., a car dealership's chatbot generating Python code, to causing serious consequences, e.g., an airline honoring refunds mistakenly promised by a chatbot. In general, these issues can introduce significant financial, regulatory, and/or brand risk to any company deploying LLM-based products in a user-facing context.

Therefore, there is a need to customize outputs from a trained AI model such that these outputs are consistent and/or predictable.

### SUMMARY

In one aspect, the present invention features a computer implemented method for automatically generating a customized textual response to a message using a trained artificial intelligence (AI) model. The method includes receiving, by a computing device, a request to customize the trained AI model. The method also includes initiating, by the computing device, a training phase comprising parsing the request to generate a set of fine-tuning parameters that includes one or more of (i) a contextual prompt configured to capture a guardrail for specifying a desired subject matter within which the response falls, and (ii) a vector-based representation of a desired tone for the response. The method further includes generating, by the computing device, the textual response to the message. This comprises inputting, by the computing device, the message and the set of fine-tuning parameters into the trained AI model and receiving, by the computing device, an initial response generated by the trained AI model to the message, where the response is guided by the fine-tuning parameters. Generating the textual response further includes comparing, by the computing device, a vector embedding of the initial response with the vector-based representation of the desired tone to verify that a similarity distance therebetween is within a predefined threshold. The computing device is adapted to output the initial response as the textual response to the message if the similarity distance is within the predefined threshold.

In another aspect, a computer-implemented system is provided for automatically generating a textual response to a message using a trained artificial intelligence (AI) model. The computer implemented system comprising a computing device having a memory for storing instructions. The instructions, when executed, configure the computer implemented system to provide an input module, a training module and a response generation module. The input module is configured to receive a request to customize the trained AI model. The training module is configured to parse the request to generate a set of fine-tuning parameters that includes one or more of (i) a contextual prompt configured to capture a guardrail for specifying a desired subject matter within which the response falls, and (ii) a vector-based representation of a desired tone for the response. The response generation module is configured to generate textual response to the message by inputting the message and the set of fine-tuning parameters into the trained AI model, receiving an initial response generated by the trained AI model to the message, the response being guided by the fine-tuning parameters, comparing a vector embedding of the initial response with the vector-based representation of the desired tone to verify that a similarity distance therebetween is within a predefined threshold, and outputting the initial response as the textual response to the message if the similarity distance is within the predefined threshold.

Any of the above aspects can include one or more of the following features. In some embodiments, the trained AI model is a large-language model (LLM). In some embodiments, the training phase further includes outputting and storing, by the computing device, an identifier of the trained AI model and the set of fine-tuning parameters for the textual response generation.

In some embodiments, if the similarity distance exceeds the predefined threshold, inputting, by the computing device, the message and the set of fine-tuning parameters into the trained AI model again to generate a second initial response. In some embodiments, the method further comprises comparing a vector embedding of the second initial response with the vector-based representation of the desired tone to verify that a second similarity distance therebetween is within the predefined threshold. In some embodiments, the initial response generation is repeated until the initial response has a similarity distance within the threshold or a predefined number of tries has been reached. In some embodiments, if the predefined number of tries has been reached and no initial response is generated that has a similarity distance within the threshold, a default response is outputted as the textual response to the message. In some embodiments, the predefined threshold and the default response is stored in a library for the trained AI model.

In some embodiments, the request includes (i) a sample reference text comprising the desired tone, (ii) the desired subject and (iii) the predefined threshold. In some embodiments, the sample reference text further comprises the desired subject.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary diagram of an automated response generation system, according to some embodiments of the present invention.

FIG. 2 shows an exemplary training phase implemented by the training module of the response generation system of FIG. 1, according to some embodiments of the present invention.

FIG. 3 shows an exemplary generative phase implemented by the response generation module of the response generation system of FIG. 1, according to some embodiments of the present invention.

### DETAILED DESCRIPTION

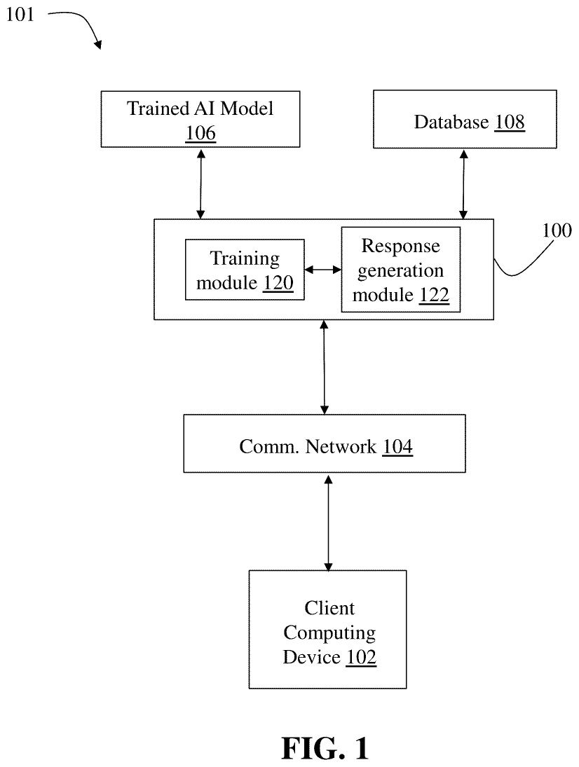

FIG. 1 shows an exemplary diagram of an automated response generation system 100 used in a computing environment 101 for automatically generating a customized response to an input message (e.g., an input query), according to some embodiments of the present invention. As shown, the computing environment 101 also includes at least one client computing devices 102, a communication network 104, a trained AI model 106 and at least one database 108.

In general, the automated response generation system 100 comprises a training module 120 configured generate a set of fine-tuning parameters that can be provided to the trained AI model 106 for guiding/customizing the response produced from the trained AI model 106. The fine-tuning parameters can specify one or more of a desired tone, mood, subject matter/context and reference material for customizing outputs from the AI model 106. In some embodiments, the fine-tuning parameters are parsed from one or more training messages supplied by a company representative via the representative's corresponding client computing device 102. The automated response generation system 100 also comprises a response generation module 122 configured to produce a streaming textual response to one or more customer messages by supplying to the trained AI model 106 the customer messages along with the fine-tuning parameters produced by the training module 120. In some embodiments, the customer messages and/or the fine-tuning parameters are supplied to the AI model 106 by a virtual agent, such as a chatbot. The virtual agent, in combination with natural language processing (NLP), can simulate human conversations and provide customer support through its interaction with the automated response generation system 100. For example, the virtual agent can engage customers in conversations to help in a variety of situations including answering questions, resolving issues, directing customers to resources, providing product information, completing transactions, etc.

In some embodiments, the response generation system 100, including the training module 120 and the response generation module 122, is a combination of hardware, including one or more processors and one or more physical memory modules, and specialized software engines that execute on a processor to receive data from other components of the computing environment 101, transmit data to other components of the computing environment 101, and perform functions as described herein. In some embodiments, the various components of the response generation system 100, including the training module 120 and the response generation module 122, are specialized sets of computer software instructions programmed onto one or more dedicated processors and can include specifically designated memory locations and/or registers for executing the specialized computer software instructions. In some embodiments, the response generation system 100 is implemented as an application programming interface (API) configured to communicate between the trained AI model 106 and the client computing devices 102.

In some embodiments, the trained AI model 106 is a trained Large Language model (LLM). In alternative embodiments, the trained AI model 106 is a different type of trained machine learning model, such as a convolutional neural network (CNN), a recurrent neural network (RNN), a generative adversarial network (GAN), or a graph neural network (GNN). In general, the user-facing API of the response generation system 100 is model-agnostic and is configured to interface with the trained AI model 106 regardless of whether it is a LLM or another type of machine learning model. Therefore, the client-facing response generation system 100 is designed for ease of use. In some embodiments, the response generations system 100 is installed locally and seamlessly works with any major publicly facing provider of the trained AI model 106, such as OpenAI, Anthropic, Llama, or a locally hosted open-source option.

The client computing device 102 can connect to the communication network 104 to interact with the response generation system 100 to provide inputs and receive outputs. In some embodiments, each computing device 102 can support one or more detailed graphical user interfaces (GUI) that allows the corresponding user to provide an input and/or display an output using the methods and systems described herein. Exemplary computing devices 102 include, but are not limited to, telephones, desktop computers, laptop computers, tablets, mobile devices, smartphones, and internet appliances. It should be appreciated that other types of computing devices that are capable of connecting to the components of the computing environment 101 can be used without departing from the scope of invention. Although FIG. 1 depicts a single computing device 102, it should be appreciated that the computing environment 101 can include any number of client devices for communication by any number of company representatives.

The communication network 104 enables components of the computing environment 101 to communicate with each other. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The database 108 can be a computing device (or in some embodiments, a set of computing devices) that is coupled to and in communication with the response generation system 100 and is configured to provide, receive and store various types of data received and/or created by the response generation system 100. In some embodiments, all or a portion of the database 108 is integrated with the system 100 or located on a separate computing device or devices. For example, the database 108 can comprise one or more databases, such as MySQL™ available from Oracle Corp. of Redwood City, California.

In some embodiments, the process implemented by the response generation system 100 of FIG. 1 to produce a guided response to one or more customer messages can be generally divided into two phases-a training phase implemented by the training module 120 and a generative phase implemented by the response generation module 122. These two phases can occur concurrently, sequentially and/or at different moments in time. The training phase allows a company representative to generate a set of fine-tuning parameters for the AI model 106, where these fine-tuning parameters are adapted to guide the AI model 106 to return a response (during the generative phase) that comply with standards set by the parameters. For example, the response can have a pre-defined tone that matches training material provided during the training phase and/or within a specified subject matter category defined in the training phase. The generative phase allows a virtual agent to pass a specific customer query (e.g., a conversation) containing messages to the AI model 106 and return a response that complies with the fine-tuning parameters from the training phase.

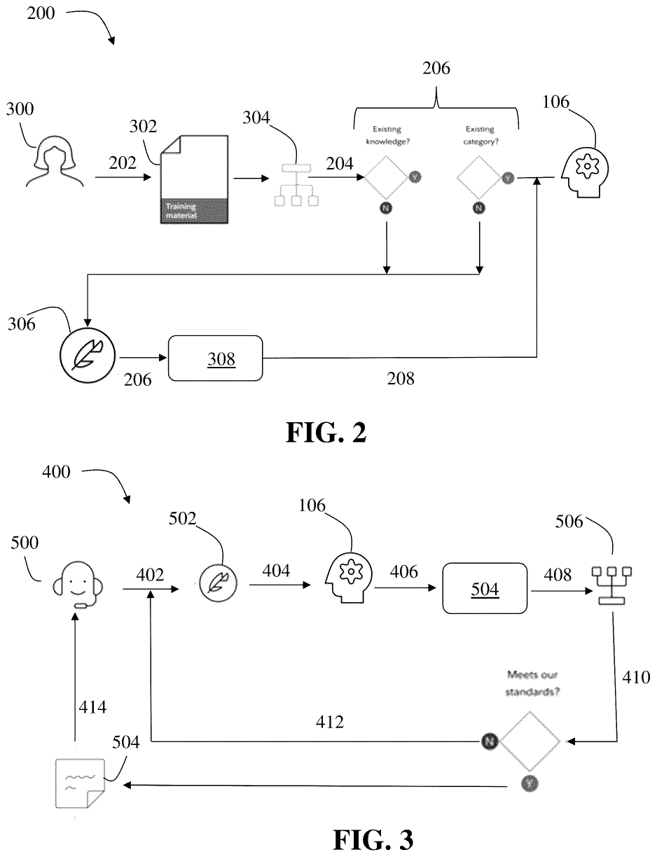

FIG. 2 shows an exemplary training phase 200 implemented by the training module 120 of the response generation system 100 of FIG. 1, according to some embodiments of the present invention. As shown, the training phase 200 is initiated by the training module 120 of the response generation system 100 upon a company representative 300 submitting (at step 202) a textual request 302 to customize (e.g., create or update) the trained AI model 106. The request 302 can be ingested by a parsing service component 304 of the training module 120. In some embodiments, the request 302 comprises tonal recommendations, such as in the form of one or more sample reference texts with desired tones and a similarity threshold that ensures the resulting output from the AI model 106 is tonally similar to the sample reference texts within the specified threshold. In some embodiments, the request 302 comprises subject matter guardrails, such as in the form of one or more reference subject matters for ensuring that the resulting output from the AI model 106 is within the specified reference subjects. Optionally, the request 302 can include one or more fallbacks that are triggered when the resulting response from the AI model 106 falls outside of the subject matter guardrails and/or the tonal recommendations. For example, the request 302 supplied by the company representative 300 can be “This conversation is about the following topics: [financial onboarding, 401k contributions]; if the incoming message or response is not part of this category, then respond with [default fallback |custom fallback].” In some embodiments, the training module 120 stores the textual request 302, including the tonal recommendations, the subject matter guardrails, the default thresholds and/or the fallbacks for a given AI model 106, in the database 108 for future reference and usage.

At step 204 of the training phase 202, the parsing service component 304 of the training module 120 is configured to analyze and parse the textual request 302 by decomposing and categorizing the request 302. Thereafter, at step 206, the training module 120 determines if the parsed request 302 already belongs to a library of existing knowledge and/or existing categories for customizing the AI model 106. This library can be stored in the database 108 corresponding to the specific AI model 106. If the parsed request 302 is determined to contribute new training information (i.e., not in the library of existing knowledge and categories), a contextual prompt service component 306 of the training module 120 is configured to further analyze the parsed request 302 to generate at least one contextual prompt 308 comprising fine-tuning parameters that captures at least one of a subject matter guardrail, desired tone and/or reference content (step 208). Optionally, the contextual prompt service component 306 can assign a new category to the newly generated contextual prompt 308. In one example, if the request 302 introduces a new training subject matter/topic, the contextual prompt 308 with fine-tuning parameters is generated to capture a subject matter guardrail, which will be used during the generative phase to ensure that the customer messages and/or resulting model responses stay within the guardrail. In another example, if the request 302 introduces a new tonal recommendation, the contextual prompt 308 with fine-tuning parameters is generated to capture a vector-based representation of the desired tone, which will be used during the generative phase to ensure that the resulting model responses align with the specified tone.

At step 208, the training module 120 stores these fine-tuning parameters (e.g., in the form of contextual prompts 308) for the given AI model 106 in the database 108 for future reference and usage. In addition, the database 108 can store in connection with the AI model 106 a library of default thresholds and/or fallbacks. In some embodiments, the training module 120 assigns a unique tokenized identifier to the fine-tuning parameters of the AI model 106. The tokenized identifier can be stored in the database 108 in correspondence to the fine-tuning parameters.

In an exemplary use case of the training phase 200 of FIG. 2, the associate 300 can upload at step 202 new training material 302 to the model 106. In this example, the new training material 302 includes content for a new topic directed to “Death: Loss of a loved one.” The parsing service component 304 decomposes and categorizes at step 204 this new training material 302 as “Loss of Loved One.” The training module 120 then determines at step 206 if this new topic is in the library of existing knowledge/category. If not, the contextual prompt service component 306 generates at step 206 a new contextual prompt 308 with fine-tuning parameters to understand that the loss of a loved one is related to the death of a family member or someone known to the deceased. Specifically, the new contextual prompt 308 can create guardrails to guide the conversation to be emotionally intelligent when the conversation involves a family member and to be more financially intelligent for contexts including more than five years, the Social Security Administration, or a credit bureau. The new contextual prompt 308 is stored at step 208 in connection with the AI model 106. The model 106 can also be associated with previously stored default thresholds and fallbacks, including how to successfully toggle conversations between financial and emotional intelligence.

FIG. 3 shows an exemplary generative phase 400 implemented by the response generation module 122 of the response generation system 100 of FIG. 1, according to some embodiments of the present invention. As shown, at step 402, a company agent 500 provides textual conversation history with customers (e.g., an array of customer messages) to the trained AI model 106. The textual data provided by the agent 500 can be in a canonical format used by most LLM's. The agent 500 can also provide a set of fine-tuning parameters (e.g., contextual prompts 308) to the AI model 106 along with the messages. These fine-tuning parameters can be identified and retrieved by the response generation module 122 based on a tokenized identifier returned by the training phase 200 and inputted by the agent 500, as described above. In general, the company agent 500 can be the same as or different from the representative 300 who trained the AI model 106 during the training phase 200. In some embodiments, the agent 500 is a virtual agent, such as chatbot, who is configured to interact with customers.

At step 404, a context service component 502 of the response generation module 122 processes the inputs supplied by the agent 500 to generate one or more augmented messages and pass these augmented messages to the trained AI model 106 for response generation. Processing the inputs by the context service component 502 may involve prepending the contextual prompts 308 to each customer message, where each contextual prompt 308 specifies one or more fine-tuning parameters including tonal parameters and/or categorical guardrails for the message as described above with reference to FIG. 2.

At step 406, the trained AI model 106 generates a response 504 based on the augmented inputs supplied by the context service component 502. The response 504 can be a static streaming textual response guided by the fine-tuning parameters of the contextual prompts 308. At step 408, the response 504 is supplied in real time (or near real time) to a verification service component 506 of the response generation module 122 to verify whether the response 504 adequately captures the desired contexts. More specifically, at step 410, if the verification service component 506 determines that the original training material 302 used to generate the contextual prompt 308 includes a specific tone, the verification service component 506 is adapted to compare the response's vector embeddings with the specified tonal vector embeddings in the original training material 302 to ascertain that the response 504 meets the tonal standard. A comparison can also be performed between the subject matter of the response 504 and the topic identified in the training material 302 to ascertain that the response 504 meets the subject matter standard. This comparison can also be accomplished on the vector-embedding level instead of a literal comparison of the texts. At step 412, if the resulting differences exceed one or more predefined similarity thresholds, indicating that the response 504 falls outside of the recommended tonal and/or subject matter parameters of the contextual prompt 308, the response 504 is discarded and a new response is requested from the trained AI model 106 by supplying the same inputs to the model 106. Alternatively, if the resulting differences are within the similarity thresholds, the response 504 is deemed as meeting the desired standards and is returned to the representative 500 at step 414.

In some embodiments, the AI model 106 and the verification service component 506 are repeatedly executed until a response 504 is generated that meets the standards set in the contextual prompts 308. Alternatively, the system 100 can keep track of the number of tries attempted and return a fallback/default message stored in the database 108 in connection with the AI model 106 if verification fails a predetermined number of times. Additionally, if an error occurs, the system 100 can automatically identify the issue (e.g., tone mismatch or prohibited content) and adjust the contextual prompt 308 for the next attempt. This approach augments the prompt rather than simply rerunning the same request, increasing the likelihood of a correct response.

In an exemplary use case of the generative phase 400 of FIG. 3, the chatbot 500 can submit (at step 402) a reference to the trained model 106 regarding a specific topic (e.g., Death: Loss of a Loved One) along with an array of customer messages. Before passing the messages to the LLM 106 (at step 404), the context service component 502 can prepend the “Loss of Loved One” as a contextual prompt to the messages. This contextual prompt 308 can also include tonal parameters for toggling between financial and emotional intelligence depending on the customer. It can further include content guardrails to avoid passing personally identifiable information to the LLM 106 and to keep the conversation focused on financial services. The LLM 106 can generate (at step 406) an initial response 504, such as “I'm sorry for your loss. Your loved one meant the world to you, and I can tell their passing has left a deep void in your life. When you're ready, I can help you sort through any of your financial matters.” The verification service component 506 (at step 410) compares the response 504 to the training material 302 used to parse the contextual prompts 308. If this response 504 doesn't meet expectations, a new response is created by re-running the LLM 106 (at step 412). The new response 504 can be “I'm sorry for your loss. If you need assistance with your accounts or just someone to talk to, we're here for you.” If the new response 504 adheres to the standards, the response 504 is delivered to the chatbot 500 (at step 414).

As another example, given the customer message/query “What are the best strategies for saving for a child's education?” in one scenario the AI model 106 is supplied with the customer query along with a set of contextual prompts that specify a friendly tonal recommendation. The response from the AI model 106 can be “Oh, what a thoughtful question! Setting up a 529 plan or an education savings account (ESA) can be a fantastic start, and you can contribute regularly to help that savings grow. You're doing an amazing job planning for your child's future!” In another scenario the AI model 106 is supplied with the same customer query along with a set of contextual prompts that specify a serious tonal recommendation. The response from the AI model 106 can be “Consider a 529 plan for tax advantaged savings and start early to maximize growth. Additionally, automate contributions to consistently build the fund.”

In some embodiments, the response generation system 100 described above with references to FIGS. 1 to 3 is configured to deploy one or more APIs for analytics, data logging and comprehensive documentation. It can deploy any number of user interfaces for updating, editing, and managing trained models. It can provide multi-language support. In addition, it can provide API security, such as authentication and authorization.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile computing device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile computing device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computer implemented method for automatically generating a textual response to a message using a trained artificial intelligence (AI) model, the method comprising:
receiving, by a computing device, a request to customize the trained AI model;
initiating, by the computing device, a training phase comprising parsing the request to generate a set of fine-tuning parameters that includes one or more of (i) a contextual prompt configured to capture a guardrail for specifying a desired subject matter within which the response falls, and (ii) a vector-based representation of a desired tone for the response; and
generating, by the computing device, the textual response to the message comprising:
inputting, by the computing device, the message and the set of fine-tuning parameters into the trained AI model;
receiving, by the computing device, an initial response generated by the trained AI model to the message, the response being guided by the fine-tuning parameters;
comparing, by the computing device, a vector embedding of the initial response with the vector-based representation of the desired tone to verify that a similarity distance therebetween is within a predefined threshold; and
outputting, by the computing device, the initial response as the textual response to the message if the similarity distance is within the predefined threshold.

2. The computer-implemented method of claim 1, wherein the trained AI model is a large-language model (LLM).

3. The computer-implemented method of claim 1, wherein the training phase further includes outputting and storing, by the computing device, an identifier of the trained AI model and the set of fine-tuning parameters for the textual response generation.

4. The computer-implemented method of claim 1, if the similarity distance exceeds the predefined threshold, inputting, by the computing device, the message and the set of fine-tuning parameters into the trained AI model again to generate a second initial response.

5. The computer-implemented method of claim 4, further comprising:
comparing a vector embedding of the second initial response with the vector-based representation of the desired tone to verify that a second similarity distance therebetween is within the predefined threshold.

6. The computer-implemented method of claim 5, further comprising repeating the initial response generation until the initial response has a similarity distance within the threshold or a predefined number of tries has been reached.

7. The computer-implemented method of claim 6, if the predefined number of tries has been reached and no initial response is generated that has a similarity distance within the threshold, outputting a default response as the textual response to the message.

8. The computer-implemented method of claim 7, further comprising, storing for the trained AI model the predefined threshold and the default response in a library.

9. The computer-implemented method of claim 1, wherein the request includes (i) a sample reference text comprising the desired tone, (ii) the desired subject and (iii) the predefined threshold.

10. The computer-implemented method of claim 9, wherein the sample reference text further comprises the desired subject.

11. A computer implemented system for automatically generating a textual response to a message using a trained artificial intelligence (AI) model, the computer implemented system comprising a computing device having a memory for storing instructions, wherein the instructions, when executed, configure the computer implemented system to provide:
an input module configured to receive a request to customize the trained AI model;
a training module configured to parse the request to generate a set of fine-tuning parameters that includes one or more of (i) a contextual prompt configured to capture a guardrail for specifying a desired subject matter within which the response falls, and (ii) a vector-based representation of a desired tone for the response; and
a response generation module configured to generate textual response to the message by:
inputting the message and the set of fine-tuning parameters into the trained AI model;
receiving an initial response generated by the trained AI model to the message, the response being guided by the fine-tuning parameters;
comparing a vector embedding of the initial response with the vector-based representation of the desired tone to verify that a similarity distance therebetween is within a predefined threshold; and
outputting the initial response as the textual response to the message if the similarity distance is within the predefined threshold.

12. The computer-implemented system of claim 11, wherein the trained AI model is a large-language model (LLM).

13. The computer-implemented system of claim 11, wherein the training module is further configured to output and store an identifier of the trained AI model and the set of fine-tuning parameters for subsequent response generation.

14. The computer-implemented system of claim 13, wherein the response generation module is further configured to input the message and the set of fine-tuning parameters into the trained AI model again to generate a second initial response if the similarity distance exceeds the predefined threshold.

15. The computer-implemented system of claim 14, wherein the response generation module is further configured to compare a vector embedding of the second initial response with the vector-based representation of the desired tone to verify that a second similarity distance therebetween is within the predefined threshold.

16. The computer-implemented system of claim 15, wherein the response generation module is configured to repeat the initial response generation until the initial response has a similarity distance within the threshold or a predefined number of tries has been reached.

17. The computer-implemented system of claim 16, wherein the response generation module is configured to output a default response as the textual response to the message if the predefined number of tries has been reached and no initial response is generated that has a similarity distance within the threshold.

18. The computer-implemented method of claim 17, further comprising a library database configured to store for the trained AI model the predefined threshold and the default response.

19. The computer-implemented method of claim 11, wherein the request includes (i) a sample reference text comprising the desired tone, (ii) the desired subject and (iii) the predefined threshold.

20. The computer-implemented method of claim 11, wherein the sample reference text further comprises the desired subject.
